(19) United States
(12) Patent Application Publication
(10) Pub. No.: US 2003/0200070 A1
(43) Pub. Date: Oct. 23, 2003

(54) Simulation of uncharacterized hardware

(76) Inventor: Mark S. Elliott, San Diego, CA (US)

Correspondence Address: Thomas D. Franklin, 3380 S. Locust St., Denver, CO, 80222, US

(21) Appl. No.: 09/797,762

(22) Filed: Mar. 1, 2001

Related U.S. Application Data
(60) Provisional application No. 60/186,017, filed on Mar. 1, 2000.

(51) Int. Cl. G06F 17/50

(52) U.S. Cl. 703/14

(57) ABSTRACT

The invention relates to simulating an electronic circuit with an uncharacterized hardware circuit. In one embodiment, a method for modeling a circuit that comprises uncharacterized hardware and a simulation system is disclosed. Uncharacterized hardware is coupled to the simulation system. The simulation system comprises at least one simulation model written with a hardware description language (HDL). An interface module integrates a computer port of the simulation system with HDL-based simulation software. The interface module is coded in a language different from the simulation model.

This application claims the benefit of U.S. Provisional Application No. 60/186,017 filed on Mar. 1, 2000.

### REFERENCE TO COMPUTER PROGRAM LISTING APPENDIXES

There are two identical compact disks filed with this application that include the following files:

1. Appendix A—physim.v.txt

2. Appendix B—physimtb.v.txt

3. Appendix C—up8051.c.txt

4. Appendix D—up8051.v.txt

5. Appendix E—physim2.v.txt

6. Appendix F—physim_tb.v.txt

7. Appendix G—physim2.c.txt

8. Appendix H—PS_{—}002.vhd.txt

All of the above files are hereby incorporated by reference into the specification of this application.

### BACKGROUND OF THE INVENTION

This invention relates in general to simulation systems and, more specifically, to simulation of digital hardware.

Conventional circuit design is crippled by the ability to accurately simulate the system prior to building the system. Without proper verification, several iterations are typically required to remove the bugs on a circuit card or ASIC. Each time the circuit card or ASIC is revised, large non-recurring expenses are encountered.

Some circuit designs rely upon off-the-shelf chips or circuits that are integrated into a larger system. Typically, some details on functionality and pin-outs are supplied in databooks, but this information is usually inadequate to create a realistic software models. Additionally, software models for these components are often difficult to get from the manufacturer and may have to be built from scratch. Where no software model is available, these components are considered uncharacterized hardware circuit. Circuit designers create support chips and circuits that integrate to the uncharacterized circuit, but have few options when testing their support chips and circuits with the uncharacterized hardware.

### BRIEF DESCRIPTION OF THE DRAWINGS

FIG. 1 is a block diagram showing one embodiment of a hardware simulation system;

FIG. 2 is a block diagram showing another embodiment of a hardware simulation system;

FIG. 3 is a block diagram showing yet another embodiment of a hardware simulation system;

FIG. 4 is a block diagram showing the embodiment of a hardware simulation system in further detail;

FIG. 5 is a block diagram showing one embodiment of an interface circuit in a hardware interface that connects to a simulation computer; and

FIG. 6 is a block diagram showing one embodiment of an interface between to a single pin of the uncharacterized hardware and the hardware interface.

### DESCRIPTION OF THE SPECIFIC EMBODIMENTS

The present invention simulates uncharacterized hardware in a software environment. With the modem design tools there is a great need to interface these tools with uncharacterized hardware for system simulations. For example, a chip designer may wish to simulate a system of modules where only some of the modules have software models compatible with the simulation software. If there is an actual module available, this invention allows interfacing the simulation software to any actual modules to allow simulation of the system.

This invention is a hardware/software solution that can interface uncharacterized electronic components with the computer simulations of other electronic components. Typically, the other electronic components are hardware description language (HDL) models of a new design that interfaces with the uncharacterized components. However, the innovative method described here is superior to many others in that it strikes a very effective balance between complexity and functionality.

In the Figures, similar components and/or features have the same reference label. Further, various components of the same type are distinguished by following the reference label by a dash and a second label that distinguishes among the similar components. If only the first reference label is used in the specification, the description is applicable to any one of the similar components having the second label.

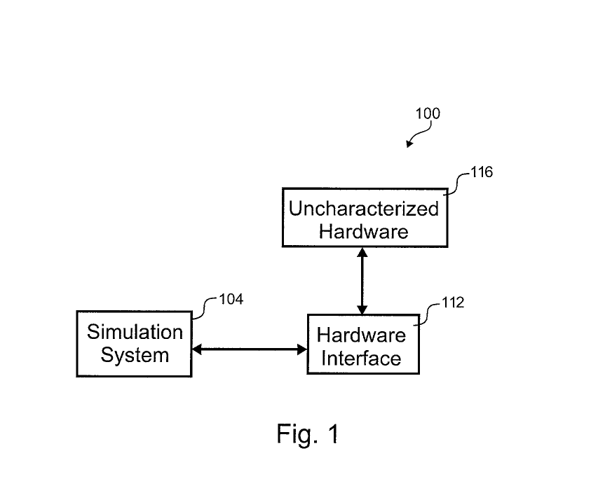

Referring first to FIG. 1, a block diagram of an embodiment of a simulation system 100 is shown. This embodiment interfaces a simulation computer 104 with a single hardware interface 112 and a single uncharacterized hardware circuit 116. The simulation system 100 merges the software models with the external uncharacterized hardware 116 to assist in hardware integration.

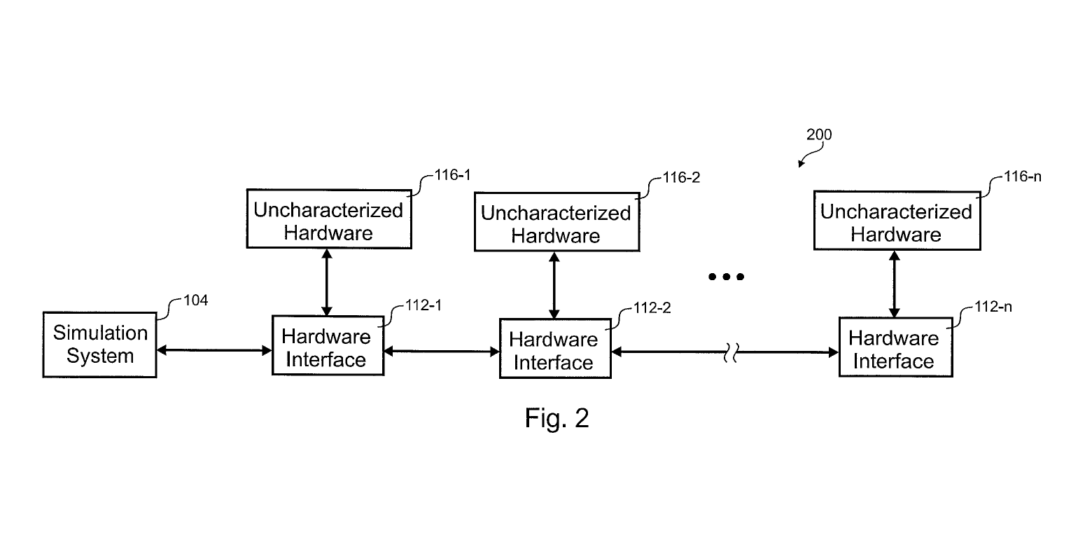

With reference to FIG. 2, a block diagram of another embodiment of a simulation system 200 is shown. This simulation system 200 attaches a simulation computer 104 with a number of hardware interfaces 112 where each hardware interface 112 is connected to a different uncharacterized hardware circuit 116. In this way, the simulation computer 104 can virtually tie the various uncharacterized hardware circuits 116 together in the simulation environment. This topology allows quick integration of the various components in a larger system without the need for software models of the uncharacterized hardware.

Each hardware interface 112 in a daisy chain of hardware devices 112 is individually addressable. When there is only a single hardware interface 112 being used, there is no need to assign unique addresses the sole hardware interface 112 so none is assigned. This embodiment assigns unique addresses to each hardware interface 112 at initialization or after a reset.

The hardware interfaces 112 are sequentially assigned addresses starting from the interface 112-1 closest to the simulation computer 104 and ending with the interface 112-n furthest from the simulation computer 104. Unless a hardware interface 112 is given an address, it does not pass data received from the simulation computer 104 down the chain. Once a first hardware interface 112-1 is addressed, however, subsequent address assignment commands are passed down the chain. The second address assignment command is received by the second hardware interface 112-2 without relaying the command further down the chain. After the second hardware interface 112-2 assigns its address, subsequent address assignment commands are passed down the chain. This process continues until all hardware interfaces 112-2 have unique addresses. Subsequent commands are addressed to hardware interfaces 112 using the assigned unique address for that interface 112.

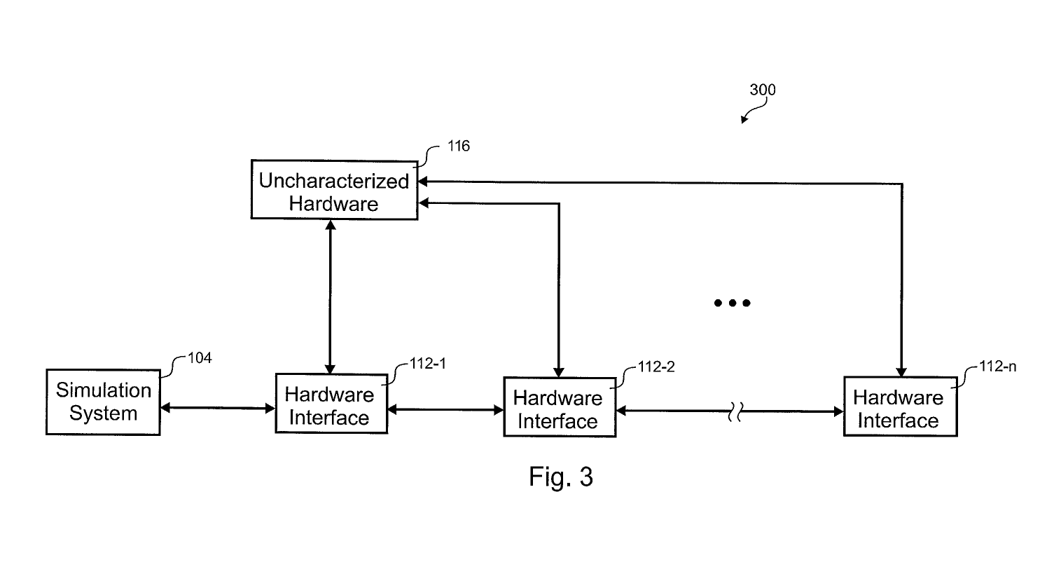

Referring next to FIG. 3, shown is a block diagram of yet another embodiment of a simulation system 300. This embodiment 200 has a number of hardware interfaces 112 coupled to a single uncharacterized hardware circuit 116. Any number of pins may be required by a particular uncharacterized hardware circuit 116. Where the I/O support of single hardware interface 112 is inadequate, any number of interfaces 112 can be daisy-chained together until all the I/O of the uncharacterized hardware 116 is coupled to the software simulation.

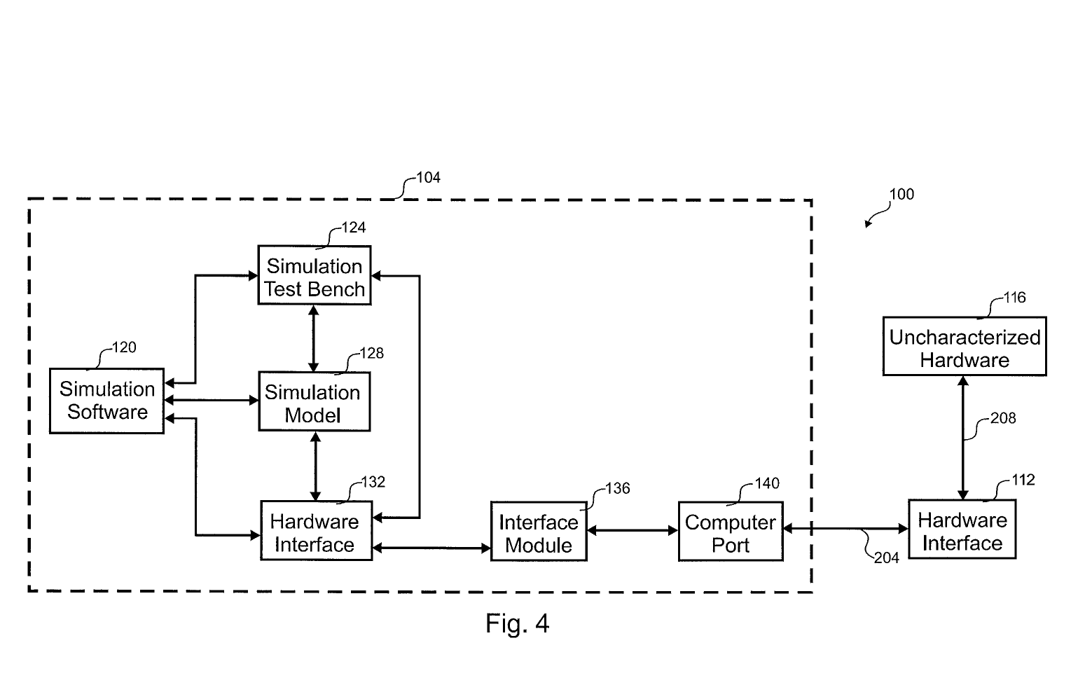

With reference to FIG. 4, a block diagram of the simulation system 100 is shown in further detail. On a simulation computer 104, the simulation software 120 makes use of an interface module dynamic link library (DLL) 136 that describes the actions of the parallel port in relation to the simulation. The interface module 136 therefore serves as the link between the simulation software 120 and the physical parallel port 140 to produce the correct electrical signals to the hardware interface 112, and ultimately, the uncharacterized hardware 116. In this embodiment, the DLL is linked to the simulation environment using a Verilog interface.

In this embodiment, the simulation software 120 runs under Microsoft™ Windows on an IBM™ compatible personal computer. The simulation software 120 is a VHDL and Verilog simulator, such as the one available from Model Technology™. Other embodiments could use simulation software 120 from Synopsis™ or any other of simulation vendors.

The uncharacterized hardware 116 can be any electronic circuit or chip for which a software module is not available. The simulation software makes use of the various software files 124, 128, 132, 136 to bring the uncharacterized hardware 116 into the simulation environment. The various software files 124, 128, 132, 136 any one of a precompiled VHDL or Verilog entity instantiation, but any HDL or simulation environment can be adapted for use in this invention. For example, PALASM or gate level netlists could be used.

A PC parallel printer port 140 contains all electrical signals that transfer the updated signal values between the software simulation and physical hardware realms. In this embodiment, the parallel port 140 is used. In other embodiments, unique interfaces or faster standard interfaces may be utilized, such as fire wire, universal serial bus, SCSI, RS-232, RS-422, PCI, PCMCIA or Ethernet.

The hardware interface 136 includes a non-configurable fixed-logic device such as an ASIC or fusable-line field programmable gate arrays (FPGAs) to reduce cost since the hardware does not normally require logical changes during operation. However, early versions may use SRAM based FPGAs which are reconfigurable. Also, the hardware 136 may contain an unlimited number of modules to support any number of pins to satisfy the number pin requirements of the uncharacterized hardware 116. This is especially useful in situations such as ASIC prototyping in which ASICs are typically strewn out amongst a large number of FPGAs with many pins potentially coupled to the interface hardware 136.

The hardware interface 112 interprets the parallel port signals from the simulation computer 104, changing signal values and transferring signal levels from the uncharacterized hardware 116 back to the parallel port 140. All reasonably fast clocks (usually from crystal oscillator outputs) originate from the simulation software 120 and the hardware interface 112. This means that any crystals in the client's uncharacterized hardware 116 are replaced with clocks signals created in the hardware interface 112. In this embodiment, there are four clock outputs from each hardware interface 112, which is usually more than enough clocks (or crystal oscillator outputs). The timing relationship of these clocks should be understood by the designer and created in the simulation with proper phasing between the clocks.

The clock driver outputs are unique from the others signals because they are changed in the physical hardware after the other signals have stabilized, mimicking register setup delays, except they operate at much lower frequencies. That is why the cables between the parallel port 140 and hardware interface 136 and the hardware interface 136 and uncharacterized hardware 116 can be rather carelessly designed, as long as the crystal oscillator clock signals (which cause register loads and therefore can not bounce) are given special care in the software simulation realm.

This raises the question of how one would integrate something such as an analog-to-digital converter (A/D) or digital-to-analog converter (D/A) into the uncharacterized hardware 116 since the analog signals can not be slowed down in the same fashion as digital signals. The answer is that the analog signals are produced from the simulation software 120. In special cases, a golden set of these analog signals can easily be sampled in real-time for use in the simulation software 120.

This system which seems complex, is actually quite easy to use and set up since there are generally no software models needed for uncharacterized hardware 116. Designers can easily create a nearly infinite number of simulation models for any uncharacterized digital device 116 without creating a software model. Integrating uncharacterized devices 116 is almost as easy to create as the port maps that define them in the simulation. The only extra bit of data needed by the simulation software 120 is which pin of the uncharacterized hardware 116 each signal in the simulation software 120 connects to. If a mistake is made, then the simulation will show incorrect output responses to input simulation, which can be easily discovered. There is little danger of logical contention blowing out drivers, as each input/output (I/O) pin on the hardware interface 112 is resistor protected.

In addition, that the first cable 204 from the simulation computer 104 to the hardware interface 112 is long doesn't pose problems because the parallel port 140 is designed for long cables. Also, the length of the second cable 208 between the hardware interface 112 and the uncharacterized hardware 116 can be long since the simulation signals run at relatively slow speeds. Edge rates of clocks are controlled also. Standard DB-25 connectors are used to connect to the hardware interface 112 between the uncharacterized hardware 116 and simulation computer 104 to make the designers job of creating cables as easy as possible. The chip designer usually creates the second cable 208 between the hardware interface 112 and the uncharacterized hardware 116 since the hardware connector to the uncharacterized hardware 116 is generally unique.

The hardware interface 112 makes connections between a simulation computer 104 running a simulation and a designer's uncharacterized hardware 116 and allows the two to interact as if: (1) both are in simulation from the chip designer's perspective or (2) both are hardware from the hardware operators perspective. For example, the uncharacterized hardware 116 could be integrated into the simulation software realm 112 because a software model of the uncharacterized hardware 116 is not readily available. Alternatively, a software model of something in the simulation environment can be integrated with physical hardware when a hardware version of the software model is unavailable. Therefore, connections with the hardware interface can generally be grouped between (a) the connection 204 to the simulation computer 104 through some kind of port, (b) the connection 208 to the uncharacterized hardware 116, and (c) connections to additional hardware interfaces 112 with corresponding uncharacterized hardware 116 in an unlimited serial or daisy-chained fashion allows attaching any number of uncharacterized hardware blocks. Additionally, daisy-chaining allows for multiple hardware interfaces 112 to attach to a single piece of uncharacterized hardware 116 to effectively increase I/O between the simulation and the uncharacterized hardware 116.

The hardware interface 112 communicates with a computer 104 by means of electrical signals transported by way of a parallel port 140 in this embodiment. In general, since the speed of the interface does not significantly hinder system performance (due to the generally long time it takes for the software to run) it turns out that rather simple interface ports are quite effective. To simplify the hardware, however, a unique protocol is used. For example, a printer port 140 may be used for the electrical interface, but a unique signal protocol would be used rather than sending ASCII characters. The unique protocol can more compactly and efficiently transfer data to the hardware interface 112. For example, when using a parallel port 140, the system 100 will know when to return information to the computer depending on the unique protocol rather than waiting for the normal Printer Done reply. If it becomes desirable to speed up the interface due to very fast computer simulation, then a much faster electrical interface may be adopted for use with perhaps a unique protocol suited to the new hardware requirements.

Unrelated to the electrical specifications of the port, the hardware interface 112 interprets the following types of protocol commands sent from the parallel port 140 in the below table:

| Command | Action |
|---|---|
| Null | Nothing happens at this address, creates a safe area |
| Reset All | Reset everything, software reset |
| Rd Include Strobe | Latch strobe to include cell in read chain |
| WR Include Strobe | Latch strobe to include cell in write chain |
| TS Strobe | Latch strobe for the tristate control value |
| WR Strobe | Latch strobe for the data out control value |
| ClkX1 | Set the clock A output (high) |
| ClkX0 | Clear the clock A output (low) |
| GoutEnb1 | Set the output enable high |
| GoutEnb0 | Clear the output enable (low) |
| Rd Enb | Creates the read pulse |
| StatusEnbSet | Status strobe - multiplex status to read port |
| StatusEnbClr | Status strobe - multiplex data to read port |
| WriteDataShift | Write Data into the shift registers |
| ReadDataShift | Read Data from the shift registers |
| AddrLd | Load module with address |
| AddrEnb | Enable Module Commands |
| AddrDis | Disable Module Commands |

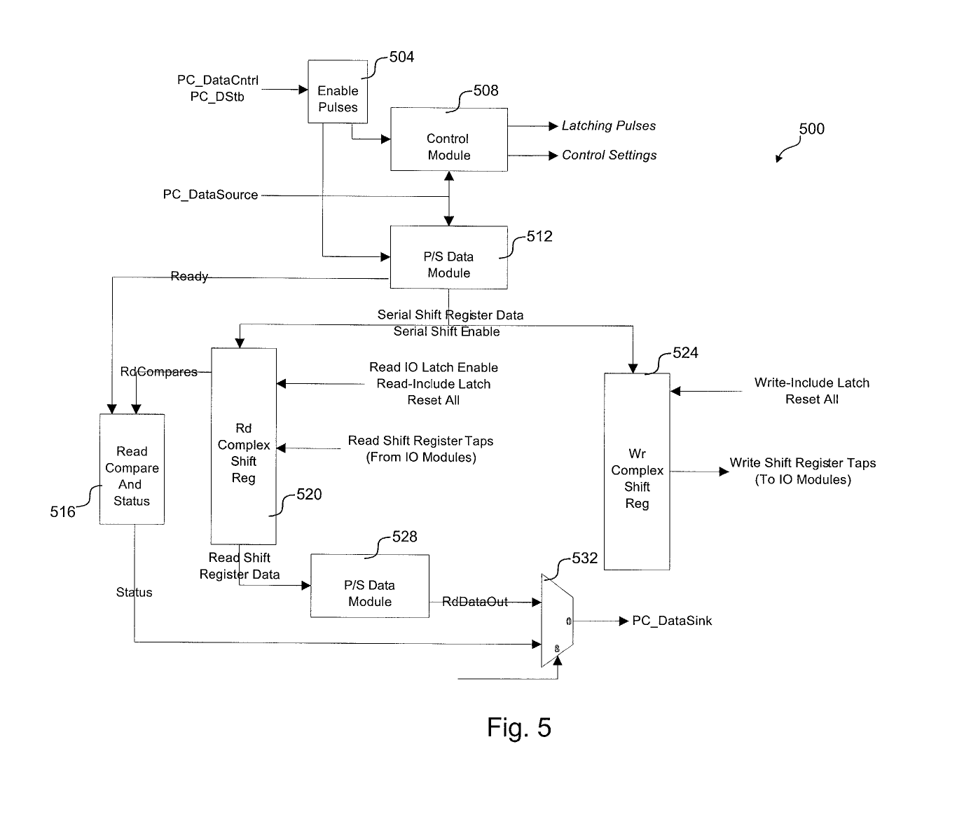

With reference to FIG. 5, a block diagram of an embodiment of at least portions of the interface 500 between the hardware interface 112 and the parallel port 140 is shown. The external signals that interface to the simulation computer 104 have the prefix “PC_” and are coupled to the first cable 104. In this example, these signals interface to a standard parallel port 140 but almost any type of port could be used in other embodiments. In the parallel port 140, whenever the data signals change, the PC_DStb signal also toggles which, in turn, creates a delayed strobe. The delay in the PC_DStb signal relative to the other port signals assures that all other port signals are stable by the time this delayed strobe activates. Toggling of the PC_DStb is done to save a write to the parallel port 140 so that it does not have to be set back to logic low. The PC_DataCntrl signal indicates if the new parallel port 140 information sent to the hardware interface 112 on the PC_DataSource bus is data byte or control byte. If a data byte is received from the PC_DataSource bus, then the data will be shifted through each of the parallel/serial converters 512 and serial shifted to the appropriate shift register 520, 524.

If the data byte from the PC_DataSource bus is control information, then an “address” is decoded to determine the pulse or the setting that will be asserted. The address is sent as a data byte associated with each control byte. Control information is used to set and clear the special clock registers. Since the clocks are typically toggled at a different time than the data to avoid race conditions, the limited number of clocks have their own commands that control their operation.

At initialization, or after a reset, each location in the shift registers 520, 524 is included in the shift to program or read the I/O pins. If a register in the shift write register 524 associated with an I/O pin is not to be used as a write location, due to the associated pin being used as an input pin, then that pin can be eliminated by shifting a ‘b 0’ to its location in the shift register 524 and issuing a WR Include Strobe command. After that has taken place, the shift register location is bypassed until the next reset or power cycle and the pin set as an output that is left in tri-state mode. When data is shifted through the registers in the shift register chain 520 to write out values to the uncharacterized hardware 116, the bypassed registers are skipped over using a multiplexer. For example, the data read from the hardware interface 112 need only include fifty bits of information if half of one hundred pins are disabled using the foregoing technique. Registers in the read shift register chain 520 can also be disabled in the same manner so that read data is not shifted from registers associated with those pins that are used as output pins. Eliminating shift registers is done to reduce the port actions to a minimum by eliminating unnecessary port reads and writes of blank information. In essence, this process reduces the size of the two sets of shift registers 520, 524 to only those needed. It is noted that unused pins are set as tri-stated outputs in this embodiment, but other embodiments could set them as inputs.

Data to be written to output pins uses the same write shift register 524 that was configured in the preceding paragraph. There are two separate bits of information for each output pin that are latched in at different times. These are the state of the logic for the pin and the state of the tri-state driver for the pin. The data bits that are latched for the output pin depends upon the command issued.

Read data is presented to the read shift register 520 after a Read Latch Command (i.e., Rd Enb command) causes all pin settings to be sampled for those coupled to the read shift register chain 520. The data is then shifted out with each data port read after a data strobe. Many times, data will not change between reads. The hardware takes advantage of this fact to make the interface even faster by using a Read Compare signal. If there has been no change in the data for the whole read chain for all inputs since the last read, then there is not need to read the new data and expend all of the associated port commands. Therefore, the status of the Read Compare pin is read from a read compare and status module 516, and if it is low, then the entire read procedure is eliminated. Conversely, pin data to be read is captured and then shifted out to a serial/parallel converter, the data strobe causes the shifting. After this, the data is read from the parallel port 140.

Status information is multiplexed onto the read port by means of a special command. Besides the Read Compare Command, there is a Ready Status Pin. This ready pin can be sampled in cases where the port is extremely fast so that the hardware will be ready for a new command before one is issued. Note that a strobe would not normally be toggled while looking at the Ready status.

Digital hardware simulations generally take place in steps that represent the fastest clock period of a system. The resolution of the simulation itself can be smaller than the clock frequency to allow the simulation of gate and wire delays between gates but the changes still take place at some small step size or resolution.

In synchronous digital designs all delays are less than a clock period and circuits simulations can be thought of as a clock toggle, followed by various combinatorial delays which generally settle out at least a set-up time before the next clock toggle. The simulation system 100 takes advantage of this common difference in signal types by designating special clock outputs that change at different times from non-clock signals. This method increases the efficiency of the simulation software 100 as well as reducing demands upon the external hardware 112, 116.

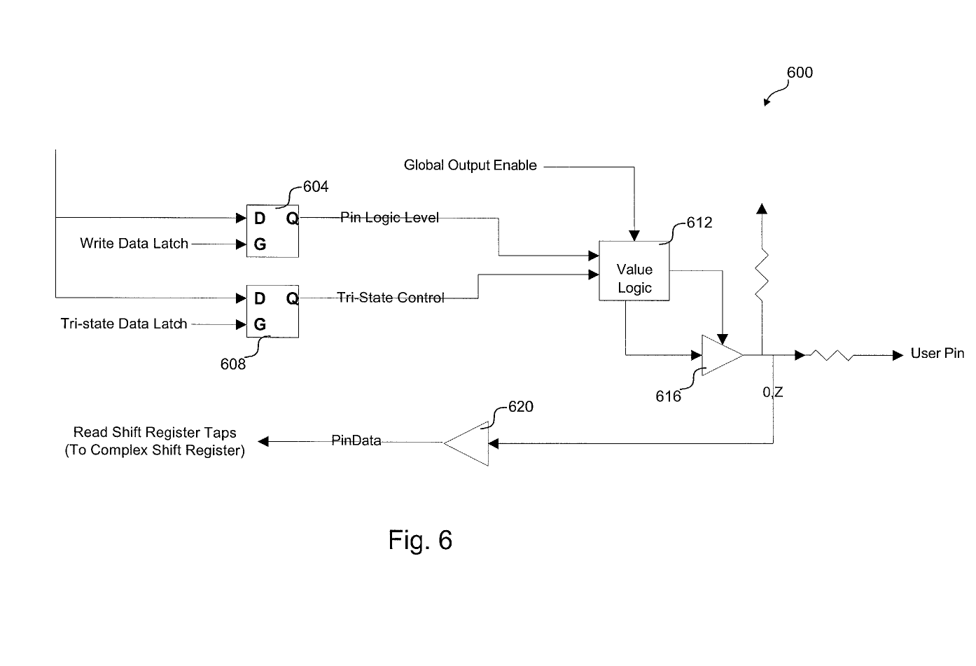

Referring next to FIG. 6, a block diagram showing one embodiment of an I/O pin 600 from the hardware interface 112 that is coupled to the uncharacterized hardware 116. Any I/O pin 600 can be programmed in the above-discussed manner to behave as an input, output or bi-directional signal. It is noted that clock pins that are output and not typically tri-stated such that they use a different pin configuration. The depicted pins are used to connect to individual pins of the user hardware whether they are used as input, output, or bi-directional signals. Series resistors protect the pins of the hardware interface 112 and the uncharacterized hardware 116 in case of logic contention. Pull-up resisters are also used for each pin 600. When the pins 600 are used as outputs the pin logic level is passed down the Write Complex Shift Register 524 to a first flip-flop 604 and then latched by the global write data latch input to the first flip-flop 604. Tri-state settings are passed down the same shift registers as the pin logic data to a second flip-flop 608 and shifted in using a global tri-state data latch input to the second flip-flop 608. The global latches in the value logic 612 change all output data at the same instant so that data does not need to change several times before reaching its final logic value. A global output enable input to the value logic 612 ensures that data is tri-stated until the pin settings have initialized after power-up or reset.

Read data is available by tri-stating the output driver 616 and latching the pin data into the Read Complex Shift Register 520. This data is then shifted out to the simulation computer 104 by reading it from the parallel port 140.

Generally speaking, simulations take place in time divisions and are known as cycle-based simulations. Although in other embodiments, actual delays can be used such that cycle-based simulations need not be used. In circuits that can be simulated this way, clock “ticks” or level changes define the time divisions between changes in signal levels. In most systems there are one or two clocks and various signals related to those clocks which change a few nanoseconds after the clock. This simulation method presents a convenient interface to the uncharacterized hardware 116 as long as the slower clocking, which presumably is the simulation controls the clocking. Therefore in this simulation system 100, the master clock exists in the simulation and is an output from the hardware interface 112 to the uncharacterized hardware 116.

The software realm of the simulation environment could vary from “canned” test vector stimulus to stimulus from high-level code such as VHDL or Verilog. The software component of the system 100 acts as a real synchronous hardware device would on a typically slower time scale. High-level code type simulation environments can generate more complex and less rigid interactions and may represent clocks, digital test data, or hardware.

The following steps discuss how one embodiment of the system 100 functions in a simulation.

A. Initialization Steps:

(1) Power-up: After power up, the shift registers 520, 524, all control signals, and latches are set to zero. Alternatively, a global reset command is run. Digital patterns are then run through the hardware interface(s) 112 and back to the simulation computer 104 to detect the number of hardware interfaces 112 that are connected in sequence. Also, this pattern check allows the software to check the hardware for compatibility and ensure a correct initialization routine. Addresses are assigned to each hardware interface 112 if there are multiple interfaces 112 daisy chained together.

(2) Initialize Read Complex Shift Register: A digital pattern is shifted into the Read Complex Shift Register 520. After the pattern has been shifted into position, a Read Include command is executed. After this is done, all shift registers that were disabled will no-longer shift data.

(3) Initialize Write Complex Shift Register: A digital pattern is shifted into the Write Complex Shift Register 524. After the pattern has been shifted into position, a Write Include command is executed. After this is done, all shift registers that were disabled will no-longer shift data.

The preceding two steps are repeated for each hardware interface 112 in a daisy chain.

B. Cyclical Steps:

(1) Clock Change: In the simulation, a clock may change its logic level. This level change is translated into a command to set the clock to the same level as in the simulation.

(2) Output Tri-state and Logic Data: A few simulation nanoseconds after the clock, a sample of all output pin and bi-direct pin tri-state settings will be taken, if there are any differences in tri-state settings, all tri-state settings will be shifted into the Write Complex Shift Register (WCSR) 524 and latched. In some embodiments, a sample of all output pin and bi-direct pin logic levels is taken. If there are any differences in any logic level, all will logic levels are shifted into the WCSR 524 and latched.

(3) Read Pin Data: A command will multiplex the status and read the Read Compare bit. If high, then all input and bi-direct pins will be latched into the Read Complex Shift Register (RCSR) 520 and data shifted out to the simulation computer 104.

(4) Read/Write Iterations: The new data is brought into the simulation if an instantaneous change occurs in some hardware interface 112 output, then step (2) is repeated. Step (3) is repeated as well to determine if the inputs to the hardware interface 112 have changed. Steps (2) and (3) are repeated until some iteration limit is reached. Since a change of inputs can cause an instantaneous change of outputs and visa-versa, these new logic levels must be resolved. Most circuits won't iterate more than once or twice. If an infinite iteration exists, then the actual circuit would represent an unstable clock and such would be reported to the user as a circuit design error.

The simulation system 100 has many potential applications in which it can be used, not limited to, but including the following:

1. ASIC Prototyping using a number of potentially uncharacterized FPGAs, which represent various ASIC modules. ASICs are commonly prototyped using multiple FPGAs. The simulation system 100 with a number of hardware interfaces 112 daisy-chained together can integrate the various FPGAs as generally depicted in FIG. 2. With even the most immense complexity, simulation times can be much faster than an all-simulation verification (since real hardware is included). Running in hardware reduces simulation times, eliminates the need for canned test vectors since a real system with real inputs are used.

The major contributor to schedule delays and cost during such design prototyping efforts is the partitioning of logic, the development of a board to hold the logic, board to board timing problems, and incorrect interfacing assumptions. The simulation system 100 can be used as a software interconnect board to connect FPGAs together. The simulation system 100 provides the master clock to the FPGAs at a typically lower frequency. The slower speed eliminates the board-to-board timing problems and assumptions can be quickly worked out.

2. In situations were an ASIC under development is connected to an existing system, the simulation system 100 may serve as a physical interface to that existing system by emulating the ASICs digital functions in the simulation system 104 using anything from hard coded response patterns to actual designs attached to other hardware interfaces 112.

3. Verification Using Real Devices: The designer no longer needs to depend on simulation models that are unpredictable, for circuits such as memories and processors. These models can be replaced behaviorally by the real thing—physical devices running as uncharacterized hardware 116 interfaced to the software simulation. This solution eliminates the time and cost of developing these models which must sometimes be created for existing hardware. Sometimes this hardware is proprietary—but developed without the use of a HDL such that a software model is not readily available. In some cases, the device is new but may have complex or incomplete specifications such that a simulation model may not be readily available.

4. Occasionally a device is not properly characterized such that the response to various stimuli is known. To solve this problem, various tests can be run with the device attached to the simulation system to quickly determine correct command sequences or stimulus. In this way, the simulation system 100 can create the stimulus and monitor the results of that test at the same time.

5. The simulation system 100 can be used to quickly produce test vectors or other stimulus. One of the first things a designer wants to know is, does the hardware react the same in the real world as it does in the simulation. This type of verification is made much easier by using the stimulus that was developed in the simulation on the physical device—thus insuring correct circuit synthesis and implementations. Other times, it may just be nice to develop your own stimulus without waiting for the software programmer to create something for you.

The software models are created using VHDL, but the simulation is done using Verilog since that is needed to have a C interface for the interface module 136. Electronically associated with this patent application as computer program listing appendixes A-D are the code used to simulate an uncharacterized 8051 microprocessor.

Appendix A (i.e., physimtb.v): The top level simulation is run in this simulation test bench file 124. This file 124 contains an 8051 module, a ROM and some stimulus to test the functionality of the external 8051, which serves as the uncharacterized hardware 116. The ROM is a behavioral model, but the 8051 is actual hardware that is instantiated at this level.

Appendix B (i.e., up8051.v): This is the 8051 simulation module 128 that appears to the simulation system to be a software model, but actually interfaces to the physical hardware 8051. This simulation module 128 is uniquely designed for each application and could interface any external uncharacterized hardware 116. As those skilled in the art can appreciate, this file could be automatically created from configuration files or a graphical user interface (GUI). Instatiated within this file is the below interface model.

Appendix C (i.e., physim.v): This interface model 132 contains the driver logic to interface the software DLL 136 to the simulation software 120. This file is normally not changed by a designer. A compiled version could be used here instead a hardware description language version such as Verilog. This software contains the $up8051 function, which is written and compiled in C. The simulation knows where to get it since a local *.dll file exists with the same name.

Appendix D (i.e., up8051.c): This is the interface module DLL 136 that contains the port commands that are needed to interface the simulation computer 104 to the hardware interface 112. This software 136 is written in the C language to interface the software simulation to the computer port 140 that connects to the hardware interface. Each implementation uses this same software routine 136, which is normally not modified by the chip designer.

Computer program listing appendixes E, F, G, and H corresponding to source files physim2.v, physim_tb.v, physim2.c, and PS_{—}002.vhd are also attached hereto as part of the patent application. These files correspond to another embodiment of this invention.

Although the invention is described with reference to specific embodiments thereof, the embodiments are merely illustrative, and not limiting, of the invention, the scope of which is to be determined solely by the appended claims.

What is claimed is:

1. A method for modeling a circuit that comprises uncharacterized hardware and a simulation system, the method comprising steps of:
coupling the uncharacterized hardware to the simulation system, wherein the simulation system comprises at least one simulation model written with a hardware description language (HDL); and
providing an interface module that integrates a computer port of the simulation system with HDL-based simulation software, wherein the interface module is coded in a language different from the simulation model.

2. The method for modeling the circuit that comprises uncharacterized hardware and the simulation system as recited in claim 1, wherein the interface module uses a Verilog program interface.

3. The method for modeling the circuit that comprises uncharacterized hardware and the simulation system as recited in claim 1, wherein a hardware interface coupled to the computer port lacks freely oscillating signals.

4. The method for modeling the circuit that comprises uncharacterized hardware and the simulation system as recited in claim 1, further comprising a step of instantiating the uncharacterized hardware.

5. The method for modeling the circuit that comprises uncharacterized hardware and the simulation system as recited in claim 1, wherein the uncharacterized hardware is a synchronous digital design.

6. A system for simulating a circuit with at least one uncharacterized hardware circuit, comprising:
simulation software adapted to execute on a simulation computer;
hardware description language (HDL) code instantiating the at least one uncharacterized hardware circuit;
an interface module coded in a language different from the HDL code; and
a hardware interface that couples the simulation software to the at least one uncharacterized hardware circuit.

7. The system for simulating the circuit with at least one uncharacterized hardware circuit as recited in claim 6, wherein the hardware interface lacks freely oscillating signals.

8. The system for simulating the circuit with at least one uncharacterized hardware circuit as recited in claim 6, wherein the hardware interface is external to the simulation computer.

9. The system for simulating the circuit with at least one uncharacterized hardware circuit as recited in claim 6, further comprising a computer port that supports a protocol chosen from the group consisting of fire wire, universal serial bus, SCSI, RS-232, RS-422, PCI, PCMCIA and Ethernet.

10. The system for simulating the circuit with at least one uncharacterized hardware circuit as recited in claim 6, wherein the at least one uncharacterized hardware is a synchronous digital design.

11. A system for simulating a circuit with at least one uncharacterized hardware circuit, comprising:
simulation software coupled to a simulation computer, wherein:
the simulation software supports a program interface,
the simulation software is adapted to execute on the simulation computer, and
the simulation computer comprises a computer port;
an interface module that uses the program interface to allow communication between a simulation environment and the computer port; and
a hardware interface adapted to couple the simulation software to the at least one uncharacterized hardware circuit.

12. The system for simulating the circuit with at least one uncharacterized hardware circuit as recited in claim 11, wherein the interface module is coded in a language other than a hardware description language.

13. The system for simulating the circuit with at least one uncharacterized hardware circuit as recited in claim 11, wherein the hardware interface is external to the simulation computer.

14. The system for simulating the circuit with at least one uncharacterized hardware circuit as recited in claim 11, wherein the program interface allows circuit designers to add functionality to the simulation software.
